(19) United States
(12) Patent Application Publication
(10) Pub. No.: US 2013/0215140 A1
(43) Pub. Date: Aug. 22, 2013

(54) PHOTO FRAMES FOR DISPLAYING PICTURES THAT ARE RELATED TO TIME ZONE MANAGEMENT

(71) Applicant: YAT WAI EDWIN KWONG, Hong Kong (HK)

(72) Inventor: YAT WAI EDWIN KWONG, Hong Kong (HK)

(21) Appl. No.: 13/398,740

(22) Filed: Feb. 16, 2012

(51) Int. Cl. G09G 5/00; G09G 3/20

(52) U.S. Cl. 345/619; 345/55

(57) ABSTRACT

Photo frames are provided for displaying pictures that are related to time zone management. In one embodiment, a photo frame is provided for switching on the photo frame based on time zone information, displaying the pictures based on the time zone information, displaying the pictures together with time zone information, and searching the pictures based on the time zone information.

### FIELD OF THE INVENTION

This invention is generally related to displaying pictures related to time management. Specifically, but not limited to, this invention relates to turning on the display of the picture frames at pre-determined times in view of time zone information, currently in the location where the picture frame is located, as well as the time zone information provided by the user during which the turning on feature is enabled.

### BACKGROUND OF THE INVENTION

Digital pictures have been popular for quite some time. One benefit for the digital pictures is that end users can modify the pictures, without seeking professional help. For example, a photo taker may modify the lighting, shading, and the size of a picture. The photo take may also insert some information into the picture through computer means. One popular addition into a photo is the date of which the photo is taken. The date can be very useful because it would help remember when a given picture is taken in the future.

One shortcoming of current picture frames is to support time zone management. Currently, a user would not be able to judge when a picture is taken. The picture may be taken on a certain date at a certain time, but there is no mechanism to record the time zone in which the picture is taken. As such, there is a need to have picture frames to support such features, so that the right pictures can be shown on the frame, in view of the time zone of the current picture frame is located, and the time zone of which the pictures are taken. With these features, a user of the picture frame can locate pictures with the right time zone information, in order to screen for other pictures that are less relevant.

### SUMMARY OF THE INVENTION

Embodiments of this invention include a photo frame for displaying pictures that are related to time zone management. Consistent with embodiments of this invention, a photo frame may comprise: a photo frame; a time zone management component; a switch on and off component; a picture; a date associated with the picture; a time associated with the picture; a time zone associated with the picture; a location detection component; a time zone searching component; a processor; and a memory containing instructions that cause the processor to execute a method.

The photo frame may be configured to perform switching on the photo frame based on time zone information, wherein the photo frame remains off and is turned on only at a pre-set time after accounting for effects of the various time zone information; displaying the pictures based on the time zone information, wherein selection of which of the pictures to display depends on the both time zone information of where the picture frame is currently located and the time zone information associated with the pictures when the pictures were taken; displaying the pictures together with time zone information, wherein the displaying includes showing graphics information as well as the corresponding time zone information of the related pictures; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

Other embodied features may includes switching on the photo frame based on time zone information, wherein the photo frame remains off and is turned on only at a pre-set time after accounting for effects of the various time zone information; allowing a user to set a timer of the photo frame, so that the photo frame is turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, wherein selection of which of the pictures to display depends on the both time zone information of where the picture frame is currently located and the time zone information associated with the pictures when the pictures were taken; displaying the pictures together with time zone information, wherein the displaying includes showing graphics information as well as the corresponding time zone information of the related pictures; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

Further, the exemplary photo frame may comprise switching on the photo frame based on time zone information, wherein the photo frame remains off and is turned on only at a pre-set time after accounting for effects of the various time zone information; allowing a user to set a timer of the photo frame, so that the photo frame is turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information.

The selection of which of the pictures to be displayed depends on the both time zone information of where the picture frame is currently located and the time zone information associated with the pictures when the pictures were taken; associating the picture with the date; associating the picture with the time; associating the picture with the time zone, automatically by location detection component; detecting that the photo frame is brought from an old time zone to the time zone; and displaying only pictures of the time zone; displaying the pictures together with time zone information, wherein the displaying includes showing graphics information as well as the corresponding time zone information of the related pictures; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

In another embodiment, the photo frame can support switching on the photo frame based on time zone information, wherein the photo frame remains off and is turned on only at a pre-set time after accounting for effects of the various time zone information; allowing a user to set a timer of the photo frame, so that the photo frame is turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, and selection of which of the pictures to display depends on the both time zone information of where the picture frame is currently located and the time zone information associated with the pictures when the pictures were taken; associating the picture with the date; associating the picture with the time; associating the picture with the time zone, automatically by location detection component; detecting that the photo frame is brought from an old time zone to the time zone; and displaying only pictures of the time zone; displaying the pictures together with time zone information, and the displaying includes showing graphics information as well as the corresponding time zone information of the related pictures; associating the picture with the date; associating the picture with the time; associating the picture with the time zone; detecting that the photo frame is currently located in the old time zone; displaying the picture together with time information, including the date and time adjusted in accordance with the old time zone; and if detecting that the photo frame has been moved to a new location of the time zone, displaying the picture together with time information, including the date and time adjusted in accordance with the new time zone; searching the pictures based on the time zone information.

The searching may then be performed based on the associated time zone information of the pictures and the current time zone located by the picture frame; and displaying national flags in accordance the with time zone information, wherein the national flags are corresponding to the time zone information of the pictures are displayed.

Switching on the photo frame may also be based on time zone information. At this point, the photo frame remains off and can be turned on only at a pre-set time after accounting for effects of the various time zone information; allowing a user to set a timer of the photo frame, so that the photo frame would be turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, wherein: selection of which of the pictures to display depends on the both time zone information of where the picture frame is currently located and the time zone information associated with the pictures when the pictures were taken; associating the picture with the date; associating the picture with the time; associating the picture with the time zone, automatically by location detection component; detecting that the photo frame is brought from an old time zone to the time zone; and displaying only pictures of the time zone; displaying the pictures together with time zone information, wherein: the displaying includes showing graphics information as well as the corresponding time zone information of the related pictures; associating the picture with the date; associating the picture with the time; associating the picture with the time zone; detecting that the photo frame is currently located in the old time zone; displaying the picture together with time information, including the date and time adjusted in accordance with the old time zone; and if detecting that the photo frame has been moved to a new location of the time zone, displaying the picture together with time information, including the date and time adjusted in accordance with the new time zone; searching the pictures based on the time zone information, wherein: the searching is performed based on the associated time zone information of the pictures and the current time zone located by the picture frame; associating the picture with the date; associating the picture with the time; associating the picture with the time zone; allowing the user to search for pictures based on time zone information; and displaying the pictures after searching for pictures based on time zone information; and displaying national flags in accordance the with time zone information, wherein the national flags are corresponding to the time zone information of the pictures are displayed.

### BRIEF DESCRIPTION OF THE DRAWINGS

FIG. 1 illustrates an exemplary photo frame, consistent with embodiments of the invention

### DETAILED DESCRIPTION

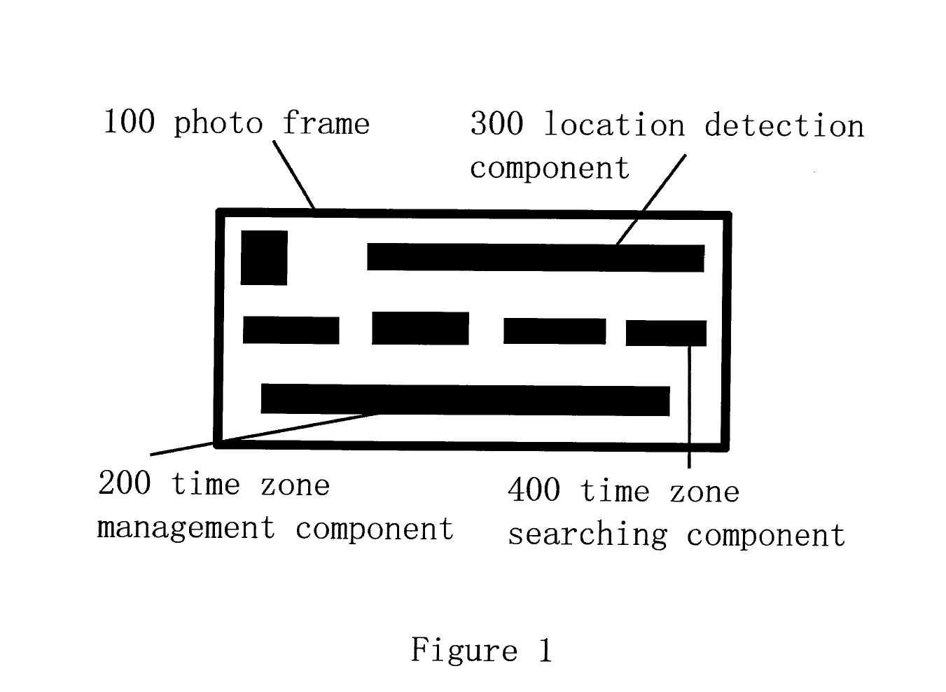

Examples are provided to show different ways to implement the inventive photo frame for displaying pictures that are related to time zone management. In one disclosure, a photo frame is disclosed by referring to FIG. 1. The photo frame comprises a photo frame; a time zone management component; a switch on and off component; a picture; a date associated with the picture; a time associated with the picture; a time zone associated with the picture; a location detection component; a time zone searching component; a processor, a memory containing instructions that cause the processor to execute a method, the method comprising: switching on the photo frame based on time zone information.

After that, the photo frame remains off and is turned on only at a pre-set time after accounting for effects of the various time zone information; displaying the pictures based on the time zone information, wherein selection of which of the pictures to display depends on the both time zone information of where the picture frame is currently located and the time zone information associated with the pictures when the pictures were taken; displaying the pictures together with time zone information, wherein the displaying includes showing graphics information as well as the corresponding time zone information of the related pictures; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

The photo frame can also possess different features. For example, the electronic device can be switched on based on time zone information, wherein: the photo frame remains off and is turned on only at a pre-set time after accounting for effects of the various time zone information; allowing a user to set a timer of the photo frame, so that the photo frame is turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, wherein selection of which of the pictures to display depends on the both time zone information of where the picture frame is currently located and the time zone information associated with the pictures when the pictures were taken; displaying the pictures together with time zone information, wherein the displaying includes showing graphics information as well as the corresponding time zone information of the related pictures; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

Further, the photo frame can remain off and is turned on only at a pre-set time after accounting for effects of the various time zone information; allowing a user to set a timer of the photo frame, so that the photo frame is turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, wherein: selection of which of the pictures to display depends on the both time zone information of where the picture frame is currently located and the time zone information associated with the pictures when the pictures were taken; associating the picture with the date; associating the picture with the time; associating the picture with the time zone, automatically by location detection component; detecting that the photo frame is brought from an old time zone to the time zone; and displaying only pictures of the time zone; displaying the pictures together with time zone information, wherein the displaying includes showing graphics information as well as the corresponding time zone information of the related pictures; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

In a different example, in setting the timer of the phone frame, the user may be required to enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, wherein: selection of which of the pictures to display depends on the both time zone information of where the picture frame is currently located and the time zone information associated with the pictures when the pictures were taken; associating the picture with the date; associating the picture with the time; associating the picture with the time zone, automatically by location detection component; detecting that the photo frame is brought from an old time zone to the time zone; and displaying only pictures of the time zone; displaying the pictures together with time zone information, wherein: the displaying includes showing graphics information as well as the corresponding time zone information of the related pictures; associating the picture with the date; associating the picture with the time; associating the picture with the time zone; detecting that the photo frame is currently located in the old time zone; displaying the picture together with time information, including the date and time adjusted in accordance with the old time zone; and if detecting that the photo frame has been moved to a new location of the time zone, displaying the picture together with time information, including the date and time adjusted in accordance with the new time zone; searching the pictures based on the time zone information, wherein the searching is performed based on the associated time zone information of the pictures and the current time zone located by the picture frame; and displaying national flags in accordance the with time zone information, wherein the national flags are corresponding to the time zone information of the pictures are displayed.

Additionally, when the photo frame remains off and is turned on only at a pre-set time after accounting for effects of the various time zone information; a user may be allowed to set a timer of the photo frame, so that the photo frame is turned on at a pre-determined time; in setting the timer of the phone frame, requiring the user enter not only the pre-determined time, but also a time zone regarding the pre-determined time; and if the photo frame is brought to a new time zone, the photo frame is turned on at the pre-determined time, in accordance not only local time of the new time zone but also the time zone regarding the pre-determined time set by the user; displaying the pictures based on the time zone information, wherein: selection of which of the pictures to display depends on the both time zone information of where the picture frame is currently located and the time zone information associated with the pictures when the pictures were taken; associating the picture with the date; associating the picture with the time; associating the picture with the time zone, automatically by location detection component; detecting that the photo frame is brought from an old time zone to the time zone; and displaying only pictures of the time zone; displaying the pictures together with time zone information.

The displaying here includes showing graphics information as well as the corresponding time zone information of the related pictures; associating the picture with the date; associating the picture with the time; associating the picture with the time zone; detecting that the photo frame is currently located in the old time zone; displaying the picture together with time information, including the date and time adjusted in accordance with the old time zone; and if detecting that the photo frame has been moved to a new location of the time zone, displaying the picture together with time information, including the date and time adjusted in accordance with the new time zone; searching the pictures based on the time zone information.

Ways of searching is not limited. For example, the searching can be performed based on the associated time zone information of the pictures and the current time zone located by the picture frame; associating the picture with the date; associating the picture with the time; associating the picture with the time zone; allowing the user to search for pictures based on time zone information; and displaying the pictures after searching for pictures based on time zone information; and displaying national flags in accordance the with time zone information, wherein the national flags are corresponding to the time zone information of the pictures are displayed.

What is claimed is:

1. A photo frame for displaying pictures that are related to time zone management, comprising:
a photo frame;
a time zone management component;
a switch on and off component;
a picture;
a date associated with the picture;
a time associated with the picture;
a time zone associated with the picture;
a location detection component;
a time zone searching component;
a processor; and
a memory containing instructions that cause the processor to execute a method.

2. The photo frame of claim 1, the method comprising:
switching on the photo frame based on time zone information, wherein the photo frame remains off and is turned on only at a pre-set time after accounting for effects of the various time zone information;
displaying the pictures based on the time zone information, wherein selection of which of the pictures to display depends on the both time zone information of where the picture frame is currently located and the time zone information associated with the pictures when the pictures were taken;
displaying the pictures together with time zone information, wherein the displaying includes showing graphics information as well as the corresponding time zone information of the related pictures;
searching the pictures based on the time zone information, wherein the searching is performed based on the associated time zone information of the pictures and the current time zone located by the picture frame; and
displaying national flags in accordance the with time zone information, wherein the national flags are corresponding to the time zone information of the pictures are displayed.

3. The photo frame of claim 1, the method comprising:
switching on the photo frame based on time zone information, wherein:
the photo frame remains off and is turned on only at a pre-set time after accounting for effects of the various time zone information;
allowing a user to set a timer of the photo frame, so that the photo frame is turned on at a pre-determined time;
in setting the timer of the phone frame, requiring the user enter not only the pre-determined time, but also a time zone regarding the pre-determined time; and
if the photo frame is brought to a new time zone, the photo frame is turned on at the pre-determined time, in accordance not only local time of the new time zone but also the time zone regarding the pre-determined time set by the user;
displaying the pictures based on the time zone information, wherein selection of which of the pictures to display depends on the both time zone information of where the picture frame is currently located and the time zone information associated with the pictures when the pictures were taken;
displaying the pictures together with time zone information, wherein the displaying includes showing graphics information as well as the corresponding time zone information of the related pictures;
searching the pictures based on the time zone information, wherein the searching is performed based on the associated time zone information of the pictures and the current time zone located by the picture frame; and
displaying national flags in accordance the with time zone information, wherein the national flags are corresponding to the time zone information of the pictures are displayed.

4. The photo frame of claim 1, the method comprising:
switching on the photo frame based on time zone information, wherein:
the photo frame remains off and is turned on only at a pre-set time after accounting for effects of the various time zone information;
allowing a user to set a timer of the photo frame, so that the photo frame is turned on at a pre-determined time;
in setting the timer of the phone frame, requiring the user enter not only the pre-determined time, but also a time zone regarding the pre-determined time; and
if the photo frame is brought to a new time zone, the photo frame is turned on at the pre-determined time, in accordance not only local time of the new time zone but also the time zone regarding the pre-determined time set by the user;
displaying the pictures based on the time zone information, wherein:
selection of which of the pictures to display depends on the both time zone information of where the picture frame is currently located and the time zone information associated with the pictures when the pictures were taken;
associating the picture with the date;
associating the picture with the time;
associating the picture with the time zone, automatically by location detection component;
detecting that the photo frame is brought from an old time zone to the time zone; and
displaying only pictures of the time zone;
displaying the pictures together with time zone information, wherein the displaying includes showing graphics information as well as the corresponding time zone information of the related pictures;
searching the pictures based on the time zone information, wherein the searching is performed based on the associated time zone information of the pictures and the current time zone located by the picture frame; and
displaying national flags in accordance the with time zone information, wherein the national flags are corresponding to the time zone information of the pictures are displayed.

5. The photo frame of claim 1, the method comprising:
switching on the photo frame based on time zone information, wherein:
the photo frame remains off and is turned on only at a pre-set time after accounting for effects of the various time zone information;
allowing a user to set a timer of the photo frame, so that the photo frame is turned on at a pre-determined time;
in setting the timer of the phone frame, requiring the user enter not only the pre-determined time, but also a time zone regarding the pre-determined time; and
if the photo frame is brought to a new time zone, the photo frame is turned on at the pre-determined time, in accordance not only local time of the new time zone but also the time zone regarding the pre-determined time set by the user;
displaying the pictures based on the time zone information, wherein:
selection of which of the pictures to display depends on the both time zone information of where the picture frame is currently located and the time zone information associated with the pictures when the pictures were taken;
associating the picture with the date;
associating the picture with the time;
associating the picture with the time zone, automatically by location detection component;
detecting that the photo frame is brought from an old time zone to the time zone; and
displaying only pictures of the time zone;
displaying the pictures together with time zone information, wherein:
the displaying includes showing graphics information as well as the corresponding time zone information of the related pictures;
associating the picture with the date;
associating the picture with the time;
associating the picture with the time zone;
detecting that the photo frame is currently located in the old time zone;
displaying the picture together with time information, including the date and time adjusted in accordance with the old time zone; and
if detecting that the photo frame has been moved to a new location of the time zone, displaying the picture together with time information, including the date and time adjusted in accordance with the new time zone;
searching the pictures based on the time zone information, wherein the searching is performed based on the associated time zone information of the pictures and the current time zone located by the picture frame; and
displaying national flags in accordance the with time zone information, wherein the national flags are corresponding to the time zone information of the pictures are displayed.

6. The photo frame of claim 1, the method comprising:
switching on the photo frame based on time zone information, wherein:
the photo frame remains off and is turned on only at a pre-set time after accounting for effects of the various time zone information;
allowing a user to set a timer of the photo frame, so that the photo frame is turned on at a pre-determined time;
in setting the timer of the phone frame, requiring the user enter not only the pre-determined time, but also a time zone regarding the pre-determined time; and
if the photo frame is brought to a new time zone, the photo frame is turned on at the pre-determined time, in accordance not only local time of the new time zone but also the time zone regarding the pre-determined time set by the user;
displaying the pictures based on the time zone information, wherein:
selection of which of the pictures to display depends on the both time zone information of where the picture frame is currently located and the time zone information associated with the pictures when the pictures were taken;
associating the picture with the date;
associating the picture with the time;
associating the picture with the time zone, automatically by location detection component;
detecting that the photo frame is brought from an old time zone to the time zone; and
displaying only pictures of the time zone;
displaying the pictures together with time zone information, wherein:
the displaying includes showing graphics information as well as the corresponding time zone information of the related pictures;
associating the picture with the date;
associating the picture with the time;
associating the picture with the time zone;
detecting that the photo frame is currently located in the old time zone;
displaying the picture together with time information, including the date and time adjusted in accordance with the old time zone; and
if detecting that the photo frame has been moved to a new location of the time zone, displaying the picture together with time information, including the date and time adjusted in accordance with the new time zone;
searching the pictures based on the time zone information, wherein:
the searching is performed based on the associated time zone information of the pictures and the current time zone located by the picture frame;
associating the picture with the date;
associating the picture with the time;
associating the picture with the time zone;
allowing the user to search for pictures based on time zone information; and
displaying the pictures after searching for pictures based on time zone information; and
displaying national flags in accordance the with time zone information, wherein the national flags are corresponding to the time zone information of the pictures are displayed.
